(19) United States
(12) Patent Application Publication
(10) Pub. No.: US 2002/0089983 A1
(43) Pub. Date: Jul. 11, 2002

(54) Switching database cache management system

(75) Inventors: Changhwa Lin, Hacienda Heights, CA (US); Zhong Wen, Tustin, CA (US)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor V.N. Inc., Irvine, CA

(21) Appl. No.: 10/015,497

(22) Filed: Dec. 12, 2001

Related U.S. Application Data
(60) Provisional application No. 60/256,302, filed on Dec. 18, 2000.

(51) Int. Cl. H04L 12/56

(52) U.S. Cl. 370/392; 370/428

(57) ABSTRACT

A network switch includes a plurality of ports, a packet engine for transferring incoming packets to an appropriate outgoing port dependent on a destination address carried in said packet, and a switching database providing switching information to said packet engine, said switching database comprising a low speed main database and a high speed cache, and a controller for transferring switching data between said database and said cache in accordance with a predetermined control policy.

### CROSS-REFERENCE TO RELATED APPLICATIONS

This application claims the benefit under 35 USC 119(e) of U.S. provisional patent application serial No. 60/256, 302 filed on Dec. 18, 2000.

### BACKGROUND OF THE INVENTION

1. Field of the Invention

This invention relates to packet switched networks, and more particularly to a cache management system for use in a switch for a local area network (LAN), for example, an Ethernet switch, supporting virtual LANS (VLANs).

2. Description of Related Art

When a packet arrives at a switch on a local area network, the switch must be capable of rapidly switching the incoming packets to the appropriate outgoing ports based on their MAC addresses. One example of such a switch, offered by Zarlink Vertex networks, is the DS226, which is a high density port count, low cost, and high performance non-blocking Ethernet switch chip. A single chip provides 24 ports at 10/100 Mbps, 2 ports at 1000 Mbps, and one 10/100 Mbps CPU interface for managed and unmanaged switch applications. The gigabit ports can also support 10/100M and 2G stacking mode.

When an incoming packet arrives at a port, the switch must look up the destination MAC address in a database in order to determine which port the incoming packet should be sent out on. State-of-the-art multi-layer switch systems require a large switching database for making packet-forwarding decisions.

Very large switching databases have considerable hardware complexity.

An object of the invention is to reduce the complexity of a large scale switching data base suitable for use in bridges, routers, and other switching devices.

### SUMMARY OF THE INVENTION

According to the present invention there is provided a network switch comprising a plurality of ports, a packet engine for transferring incoming packets to an appropriate outgoing port dependent on a destination address carried in said packet, and a switching database providing switching information to said packet engine, said switching database comprising a low speed main database and a high speed cache, and a controller for transferring switching data between said database and said cache in accordance with a predetermined control policy.

The invention allows the most frequently stored addresses, typically MAC addresses, to be stored in a high speed cache. These addresses can be rapidly located using high speed search hardware. When an incoming packet arrives at the switch, the switch first looks for the destination address in the cache, and only if it fails to find the address in the cache does it look in the main lower speed switching database.

The majority of the switching information is stored in the lower speed database. By intelligently controlling the storage of data in the high speed data base, the performance of the switch can be significantly improved.

### BRIEF DESCRIPTION OF THE DRAWINGS

The invention will now be described in more detail, by way of example only, with reference to the accompanying drawings, in which:

FIG. 1 is a block diagram of a typical packet switch; and

FIG. 2 is a block diagram of a intelligent cache system in accordance with the invention.

### DETAILED DESCRIPTION OF THE PREFERRED EMBODIMENTS

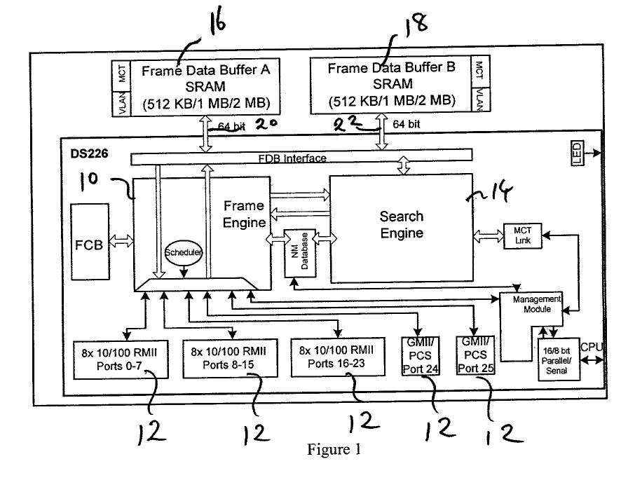

FIG. 1 shows a typical switch suitable for switching Ethernet frames. The switch comprises a frame engine 10 connected to ports 12 for transmitting and receiving packets from a network. The packets are typically Ethernet frames carried on a local area network. The task of the frame engine 10 is to switch incoming frames to the appropriate outgoing ports based on the destination address carried in the frame. The address will be the physical address, known as the MAC (Media Access Control) address. This is a hardware address that uniquely identifies each node on the network.

When an incoming frame arrives at the switch, the search engine 14 is responsible for identifying the appropriate output port for an incoming frame based on the MAC address carried in the frame.

In order to ensure a non-blocking switch, two memory domains 16, 18 are required. Each has a 64 bit wide memory bus 20, 22 connected to FDB interface 24. The switching database (not shown in FIG. 1) is located in external SRAM.

The switching database stores the port information for all MAC addresses on the network. For large networks, the number of MAC addresses can be large, resulting in highly complex systems.

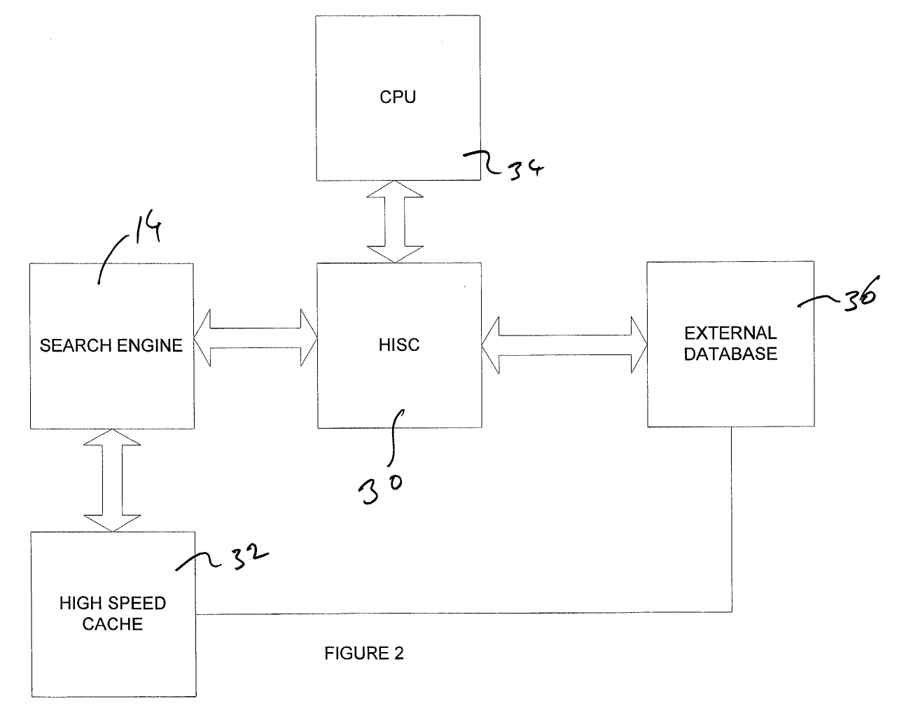

FIG. 2 shows more details of the search engine 14. As shown in FIG. 2, search engine 14 is connected to an external main switching database 30, which can be of relatively low speed, and a smaller high speed cache 32. This is a high performance database that supports packet forwarding at full line rate.

The search engine is connected through a HISC (hierarchial instruction set computer) to a main database 36 and a central processing unit (CPU) 34.

In order for the system to operate efficiently, a switching policy must be put in place that makes efficient use of the resources available. Ideally, the most frequently accessed entries should be available at all times in the high speed cache 32.

The switching database system allows any of the databases to learn, delete or modify new entries. This can happen under low level hardware or high level software control. Any entry can also be modified upon request. For example, if a host switches port the filtering entry must be modified in some or all of the databases.

When the resources in the databases become low, the replacement policy selects entries for candidates for deletion, so that new entries can be loaned or inserted. The replacement policy determines when to execute this task, for example when an entry has been recently used.

When the resources of the high speed database 32 become low, the cache replacement policy selects entries in the database as candidates for deletion, moving, or swapping, so that new entries can be inserted into the high speed database 32.

An aging policy provides a mechanism for dealing with entries that have not been used in the database system for a predefined period of time. All unused entries are marked or deleted in part or all of the databases.

An incoming packet is forwarded on the information found in either the high speed or low speed databases. The search engine 14 first looks in the high speed database, and if the entry is not found there looks in the lower speed database 30. If the packet forwarding order needs to be maintained, the packet forwarding policy must comply with this requirement. An entry usage indication can be passed to the replacement mechanism for making replacement decisions.

In the case of an incoming packet for which the entry cannot be found in any of the databases, the packet can either be dropped or forwarded to a port group that includes part of the ports or all ports. The packet whose destination cannot be found in the databases can use the same ordering policies discussed above for forwarding packets.

With the described switching database cache system, only minimal switching base database information need be stored in the high speed cache 32 which employs high speed search hardware. The majority of switching information is stored in the low cache, large scale, lower speed switching database 36. The content of the database cache system can be created, modified, or deleted by the request from the high level management software/hardware and low level hardware learning engine. Based on the run time traffic patterns and the desired behavior from the administrator, the intelligent cache management system swaps the database entries between the high speed and the low speed switching databases under the control of a set of rules that govern the swapping.

By way of example, in a bridge filtering database implementation, the database cache can move the filtering entries from the high speed filtering entry search engine to a low speed filtering entry search speed if the entries are not used for a long time. The filtering entries that are requested constantly are in the high speed filtering database engine due to the response time. For the filtering entries that are requested constantly are kept in the high speed filtering database search engine to reduce response time.

The described database cache system can be implemented for a bridge filtering database, a layer 3 routing/switching database, a web switching database, or any other multi-layer switching databases.

The described invention allows the implementation of a large scale switching database with a much lower hardware complexity. The intelligent cache management mechanism can be implemented in hybrid hardware, software, or firm ware solutions.

With advances in network processors, the intelligent cache management system can be implemented in firm ware running with a high performance co-engine.

Although the present invention has been described and illustrated in detail, it is clearly understood that the same is by way of illustration and example only and is not to be taken by way of limitation, the spirit and scope of the present invention being limited only by the terms of the appended claims.

We claim:

1. A network switch comprising a plurality of ports, a packet engine for transferring incoming packets to an appropriate outgoing port dependent on a destination address carried in said packet, and a switching database providing switching information to said packet engine, said switching database comprising a low speed main database and a high speed cache, and a controller for transferring switching data between said database and said cache in accordance with a predetermined control policy.

2. A network switch as claimed in claim 1, wherein said high speed cache includes a high speed search engine implemented in hardware.

3. A network switch as claimed in claim 1, wherein said controller is a hierarchical instruction set microcontroller.

4. A network switch as claimed in claim 3, wherein said high speed cache is located in a fast path to support packet forwarding at full line rate.

5. A method of forwarding packets in a network switch, comprising providing a switching database for storing destination address information, said switching database being divided into a main lower speed database and a high speed cache; searching for address information for an incoming packet first in said high speed cache, and in the event said information is not in said high speed cache subsequently searching for said information in said lower speed lower speed database; and controlling the transfer of data between said high speed cache and said lower speed database in accordance with a predetermined policy.

6. A method as claimed in claim 5, wherein database entries are deleted or transferred to said lower speed database when the resources in said high speed cache become low.

7. A method as claimed in claim 6, wherein database entries that have not been used for a predetermined period of time are marked for deletion.

8. A method as claimed in claim 7, wherein in the event that an entry cannot be found for an incoming packet, said incoming packet is dropped or forwarded to a designated port group that includes all or part of the ports of said network switch.
